(19) United States
(12) Patent Application Publication
(10) Pub. No.: US 2007/0143628 A1
(43) Pub. Date: Jun. 21, 2007

(54) User authentication method, system provided with user authentication function, and, apparatus and computer software provided with user authentication function

(75) Inventor: Daisuke Genda, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/639,233

(22) Filed: Dec. 15, 2006

(30) Foreign Application Priority Data
Dec. 20, 2005 (JP) JP2005-366176
Feb. 21, 2006 (JP) JP2006-043534

(51) Int. Cl. H04L 9/00; H04K 1/00

(52) U.S. Cl. 713/183; 713/186; 713/184

(57) ABSTRACT

A user authentication method including the steps of: accepting input of biological information; displaying a user authentication screen in which a user name corresponding to the biological information and a part of a password corresponding to the user name are automatically entered; and accepting input for completing the password, the part of which have been automatically entered.

### CROSS REFERENCE TO RELATED APPLICATION

This application is based on Japanese Patent Application No. 2005-366176 and No. 2006-043534 respectively filed on Dec. 20, 2005 and Feb. 21, 2006 with Japanese Patent Office, the entire content of which is hereby incorporated by reference.

### BACKGROUND OF THE INVENTION

1. Field of the Invention

The present invention relates to user authentication method, systems provided with user authentication functions, and, apparatuses and computer software provided with user authentication functions.

2. Background Technology

For the sake of security, the user is required to input a login ID and a password at the time of logging in a personal computer or an image forming apparatus provided with a hard disk drive in which documents can be accumulated.

It is tedious to input the login ID and password every time for logging in and in order to eliminate this tedium, a technology has been known (see for example, Patent Document 1) in which the fingerprint authentication data is stored associating it with a login ID and its password, and when the fingerprint authentication is successful, the associated login ID and password are input automatically in the login ID field and the password fields of the login input screen.

Patent Document 1: Japanese Unexamined Patent Application Publication No. 2003-36247.

In general, in biometric authentication such as fingerprint authentication, the degree of matching between the feature data that has been input and the registered feature data is computed, and the authentication is done assuming a match to be present for the feature data for which the degree of matching is above a certain value.

Because of this, it is likely that another person having the similar feature data is wrongly authenticated as the genuine user, and in the method disclosed in Patent Document 1, there is the danger that another person can login using the login ID and password using the genuine user. Further, it is also likely that a plurality of candidates are extracted, and in the method disclosed in Patent Document 1, there is no consideration given to the method of handling when a plurality of candidates have been extracted.

The present invention has been made with the above problem in view, and the object of the present invention is to provide a user authentication method in which not only the input at the time of logging in becomes simple but also logging in by another person with the login ID and password of the genuine user is suppressed, and it is possible to handle even when a plurality of candidates have been extracted.

### SUMMARY OF THE INVENTION

An embodiment reflecting one aspect of the present invention to achieve the above-described object is a user authentication method including the steps of:

accepting input of biological information;

displaying a user authentication screen in which a user name corresponding to the biological information and a part of a password corresponding to the user name are automatically entered; and

accepting input for completing the password, the part of which have been automatically entered.

An embodiment reflecting another aspect of the present invention is a user authentication method including the steps of:

accepting input of biological information;

extracting user data corresponding to the biological information accepted;

displaying user candidates based on the user data extracted;

accepting a selection of a specific user among the user candidates displayed;

displaying a user authentication screen in which a part of a password corresponding to the specific user selected is automatically entered; and

accepting input for completing the password, the part of which have been automatically entered.

### BRIEF DESCRIPTION OF THE DRAWINGS

These and other objects, advantages and features of the invention will become apparent from the following description thereof taken in conjunction with the accompanying drawings in which:

FIG. 1 is a block diagram showing the configuration of an image forming apparatus according to the present preferred embodiment;

FIG. 2 is a control flow diagram related to the login process of the image forming apparatus according to the first preferred embodiment;

FIG. 3 is an example of the login screen in the first preferred embodiment;

FIG. 4 is an example of another login screen in the first preferred embodiment;

FIG. 5 is a control flow diagram related to the login process of the image forming apparatus according to the second preferred embodiment;

FIG. 6 is an example of the selection input screen when a plurality of candidates are present in second preferred embodiment;

FIG. 7 is an example of the login screen in the second preferred embodiment; and

FIG. 8 is an example of another login screen in the second preferred embodiment.

### DETAILED DESCRIPTION OF THE PREFERRED EMBODIMENTS

Apparatus Configuration:

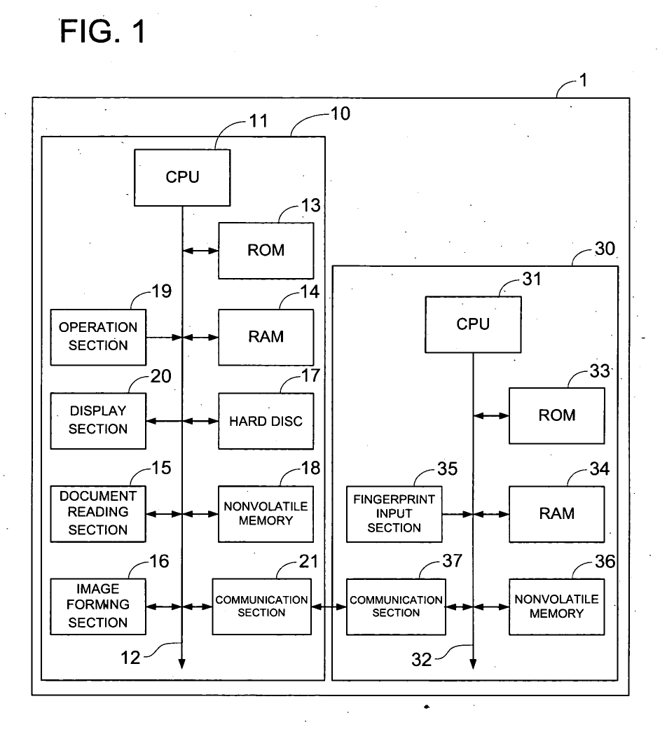

FIG. 1 is a block diagram showing the configuration of an image forming apparatus 1 according to the first preferred embodiment. The image processing apparatus 1 is configured to have the apparatus main unit 10 and a fingerprint authentication module 30.

In the apparatus main unit 10, at the center is the CPU 11 that executes control of the apparatus main unit 10 according to the programs and is connected mutually via the bus 12 to a ROM 13, a RAM 14, a document reading section 15, an image forming section 16, a hard disk 17, a non-volatile memory 18, an operation section 19, a display section 20, and a communication section 21.

The ROM 13 stores various types of programs and data and the CPU 11 carries out control of the image forming apparatus 1 using these programs and data.

The RAM 14 is used as a working storage by the CPU 11 and temporarily stores the programs and data necessary at the time that the CPU 11 carries out the controls.

The document reading section 15 reads out the original document and generates the image data. The image data so generated is output to the image forming section 16 or the hard disk 17 etc.

The image forming section 16 carries out image formation on a recording medium based on the image data or document data input from the document reading section 15 or the hard disk 17 etc.

The hard disk 17 stores the image data input from the document reading section 15 etc.

The non-volatile memory 18 stores the user login ID and the password for each user while establishing correspondence with a registration number.

The operation section 19 is operated by the user, and input of the login ID and the password, instruction of image formation, and instruction of storing data in the hard disk 17, etc., are carried out through this operation section 19.

The display section 20 displays screens such as the user login screen that accepts the input of the login ID and the password from the user. The display section 20 includes a touch panel, which may be also used for the operation section 19.

The communication section 21 is connected to the fingerprint authentication module 30 to be described later, and transmits the instruction of fingerprint authentication to the fingerprint authentication module 30.

The fingerprint authentication module 30, at the center is the CPU 31 that executes control of the fingerprint authentication module 30 according to the programs, is connected mutually via the bus 32 to a ROM 33, a RAM 34, a fingerprint input section 35, a non-volatile memory 36, and a communication section 37.

The ROM 33 stores various types of programs and data and the CPU 31 carries out control of the fingerprint authentication module 30 using these programs and data.

The RAM 34 is used as a working storage by the CPU 31 and temporarily stores the programs and data necessary at the time that the CPU 31 carries out the controls.

The fingerprint input section 35 reads the fingerprint of the user to generate the fingerprint data.

The non-volatile memory 36 is a memory for storing the generated fingerprint data and stores the fingerprint data while establishing correspondence with a registration number.

The communication section 37 is connected to the apparatus main unit 10, and when a fingerprint authentication is successful, it transmits to the apparatus main unit 10 the registration number stored in the non-volatile memory 36 and the degree of matching at the time of authentication.

### First Embodiment

Apparatus Control:

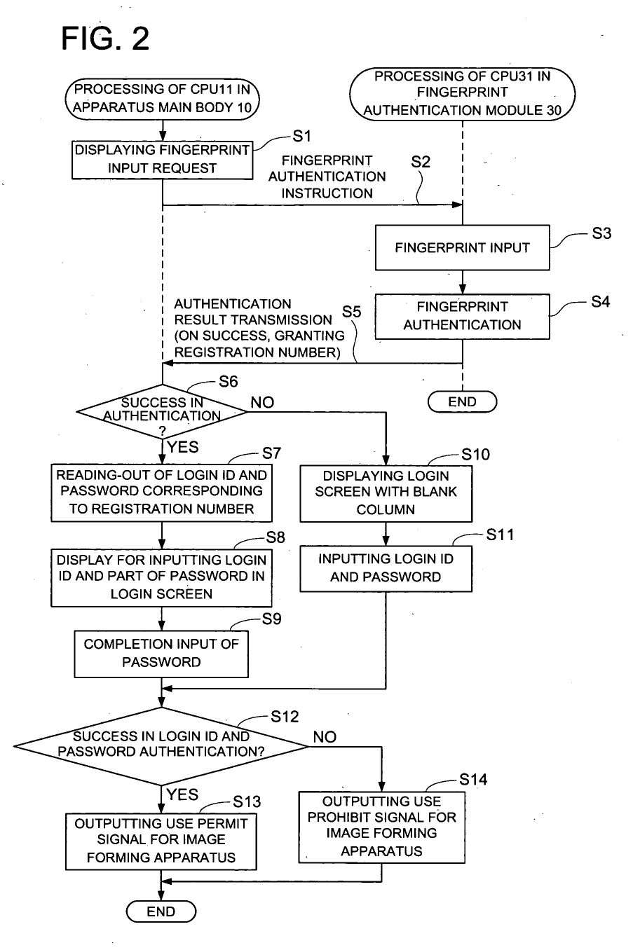

FIG. 2 is a control flow diagram related to the login process of the image forming apparatus according to the first preferred embodiment. This control is carried out by the CPU 11 and CPU 31 executing the processing in cooperation with each other based on the programs stored in ROM 13 and ROM 33.

To begin with, the CPU 11 displays in the display section 20 a message, for example, “enter fingerprint” (Step S1). Further, the CPU 11 instructs the CPU 31 to carry out fingerprint authentication (Step S2). Following this instruction, the user places his/her finger in the fingerprint input section 35.

Next, the CPU 31 causes the fingerprint input 35 to read the fingerprint of the user and to input the fingerprint data (Step S3).

Next, the CPU 31 carries out fingerprint authentication by judging whether there exists any fingerprint data to match with the input fingerprint data among the fingerprint data stored in the non-volatile memory 36 (Step S4).

Next, the CPU 31 transmits the result of authentication (authentication successful or authentication failed) to the apparatus main unit 10 via the communication section 37 (Step S5). If the authentication is successful, it adds to the transmission the registration number corresponding to the matching fingerprint data.

Next, the CPU 11 judges whether or not the authentication result transmitted from the fingerprint authentication module 30 was successful (Step S6). If authentication is successful (Step S6: YES), the CPU 11 reads out the login ID and password corresponding to the added registration number into the RAM 14 from the non-volatile memory 18 (Step S7).

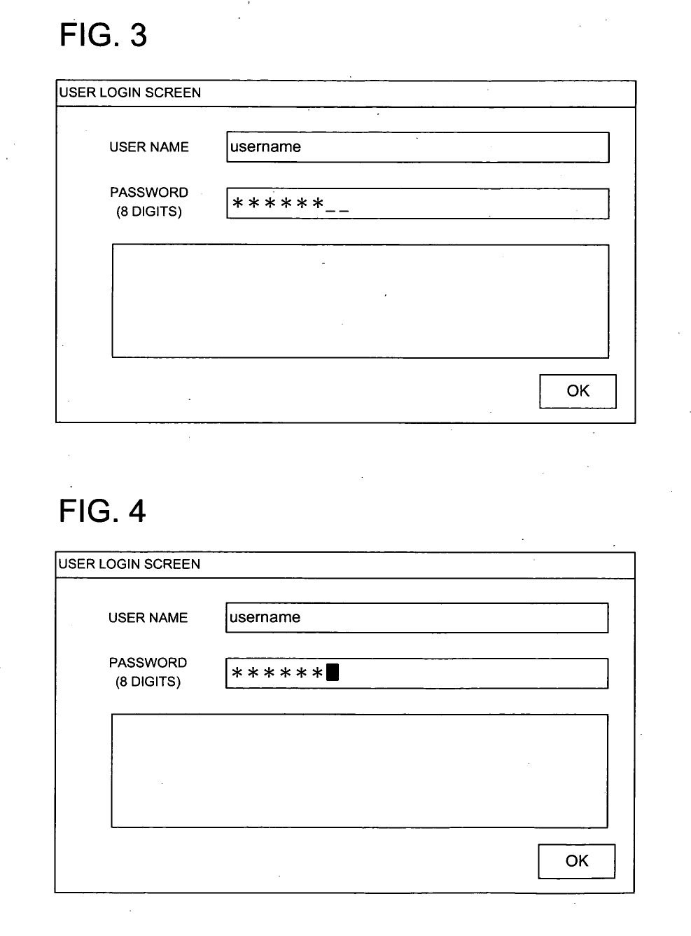

Next, the CPU 11 displays the login screen which displays the login ID read out in Step S7 and a part of the password in the display section 20, and prompts the user to make the completion input of the password (Step S8). For example, as is shown in FIG. 3, if the password has eight characters, the leading 6 characters of the password are input automatically and are displayed by six asterisks ‘*’ and the last asterisk ‘*’ is followed by the display of two underscored characters. Following this display, the user makes the completion input of the password from the operation section 19. In the case of the example shown in FIG. 3, the user makes the completion input of the remaining two characters in the part displayed by underscores. By displaying the number of characters to be input using underscores etc., for example, even when a password with a large number of characters is being displayed, the user can immediately recognize which characters are to be input.

With this, the completion input of the password is made to the CPU 11 (Step S9). In the case of the example shown in FIG. 3, the login screen displays two asterisks ‘*’ in addition at the end of the six asterisks ‘*’ displayed earlier.

By making the user carry out completion input in this manner, even if the collation is successful while wrongly recognizing another person as the genuine user, since that other person cannot login as it is, but has to complete the password, another person logging in with the login ID and password of the genuine user is suppressed.

In Step S6, if the authentication has failed (Step S6: NO), the operation proceeds to Step S10, and the CPU 11 displays, in the display section 20, a login screen with the login ID and password fields empty, and prompts the user to enter the login ID and password. Following this instruction, the user enters all the characters of the login ID and password through the operation section 19.

For example, if the fingerprint registration condition is bad, and even if the fingerprint authentication has failed in spite of the user being the genuine user, it is possible for the user to login by entering all the characters of the login ID and password.

In Step S11, all the characters of the login ID and password are input to the CPU 11.

In Step S9 or Step S11, when the login ID and password are input and logging in is made, the CPU 11 refers to the login IDs and passwords stored in the non-volatile memory 18 to cross-check with the entered login ID and password, and carries out authentication of the entered login ID and password (Step S12). If the authentication is successful (Step S12: YES), the CPU 11 outputs the use permission signal to the image forming apparatus (Step S13). If the authentication has failed (Step S12: NO), the CPU 11 outputs the use prohibit signal to the image forming apparatus (Step S14).

In the above manner, according to the present preferred embodiment, at the time of automatically inputting the login ID and password in the login ID field and the password field of the login input screen due to success of biometric authentication, since the entire password is not input automatically but a part of it is made to be entered by the user, not only that the input becomes simple at the time of logging in, but also logging in by another person using the login ID and password of the genuine user is suppressed.

Although in the present preferred embodiment, the trailing part of the password was made the target of completion input by the user, it can also be the leading part or a middle part of the password. Since it is easy for the user to remember the leading and the trailing parts, it is desirable to use these for the completion input.

Further, although in the present preferred embodiment, the example of using a number of underscores equivalent to the number of characters of the completion input was explained as an example of the display for prompting for and accepting the completion input from the user, the present invention shall not be construed to be limited to this mode of display, and, for example, the display mode can also be line the one shown in FIG. 4. In the example of this figure, considering, for the sake of explanation, that the password has eight characters similar to that shown in FIG. 3, in addition to carrying out the automatic input of the leading six characters of the password and displaying them by six asterisks ‘*’, the prompt following the last asterisk character ‘*’ is displayed by a prompt character (for example, by a blinking cursor). In the example of this figure, the user carries out completion input of the remaining characters according to the prompt characters. Here, when even the number of characters in the password differs depending on the user, only the genuine user can know how many characters have to be input following the prompt. In this manner, in the case of the present preferred embodiment, it is possible to make the number of characters of the password have the same kind of meaning as the password itself, and is desirably suitable for achieving security.

Although in the present preferred embodiment, the fingerprint data was stored in the non-volatile memory 36 of the fingerprint authentication module 30 while establishing correspondence with the registration number, the login ID and password were stored in the non-volatile memory 18 of the apparatus main unit 10 while establishing correspondence with the registration number, and the login ID and password corresponding to the fingerprint were identified by transmitting the registration number from the fingerprint authentication module 30 to the apparatus main unit 10 when the authentication by the fingerprint authentication module 30 was successful, it is also possible to store the login IDs and passwords in the non-volatile memory 36 of the fingerprint authentication module 30, and to transmit to the apparatus main unit 10 the login ID and the password stored in the non-volatile memory 36 from the fingerprint authentication module 30 when the authentication by the fingerprint authentication module 30 is successful.

### Second Embodiment

Apparatus Control:

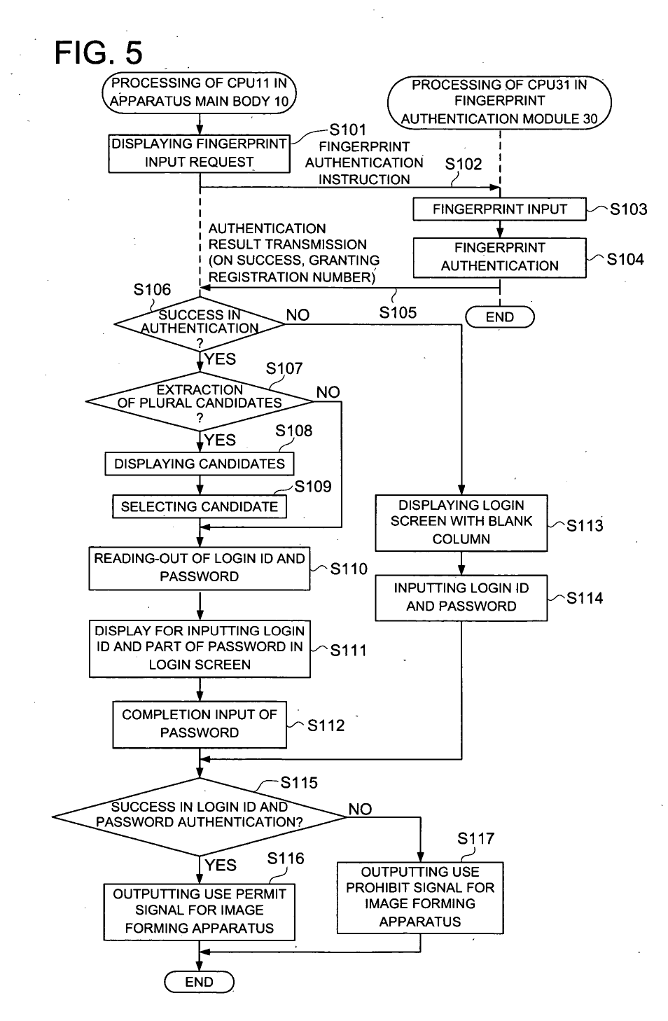

FIG. 5 is a control flow diagram related to the login process of the image forming apparatus of FIG. 1 according to the second preferred embodiment. This control is carried out by the CPU 11 and CPU 31 executing the processing in cooperation with each other based on the programs stored in ROM 13 and ROM 33.

To begin with, the CPU 11 displays in the display section 20 a message, for example, “enter fingerprint” (Step S101). Further, the CPU 11 instructs the CPU 31 to carry out fingerprint authentication (Step S102). Following this instruction, the user places his finger in the fingerprint input section 35.

Next, the CPU 31 causes the fingerprint input 35 to read the fingerprint of the user and to input the fingerprint data (Step S103).

Next, the CPU 31 carries out fingerprint authentication by judging whether there exists any fingerprint data to match with the input fingerprint data among the fingerprint data stored in the non-volatile memory 36 (Step S104).

Next, the CPU 31 transmits the result of authentication (authentication successful or authentication failed) to the apparatus main unit 10 via the communication section 37 (Step S105). If the authentication is successful, it adds to the transmission the registration number corresponding to the matching fingerprint data. When a plurality of candidates of matching fingerprint data are present, the registration number and the degree of matching corresponding to the fingerprint data of each candidate are added and transmitted as the data. By transmitting the data after adding the degree of matching, at the time of displaying later a plurality of candidates in the apparatus main unit 10, it is possible to display in decreasing order of the degree of matching. In addition, when number of candidates is present, it is also possible to transmit while limiting the data to a certain number of candidates in the top of the list or to a top few percent of the candidates in the data.

Next, the CPU 11 judges whether or not the authentication result transmitted from the fingerprint authentication module 30 was successful (Step S106). If authentication is successful (Step S106: YES), the CPU 11 judges whether or not a plurality of candidates were extracted (Step S107). If the authentication had failed (Step S106: NO), the processing proceeds to Step S113.

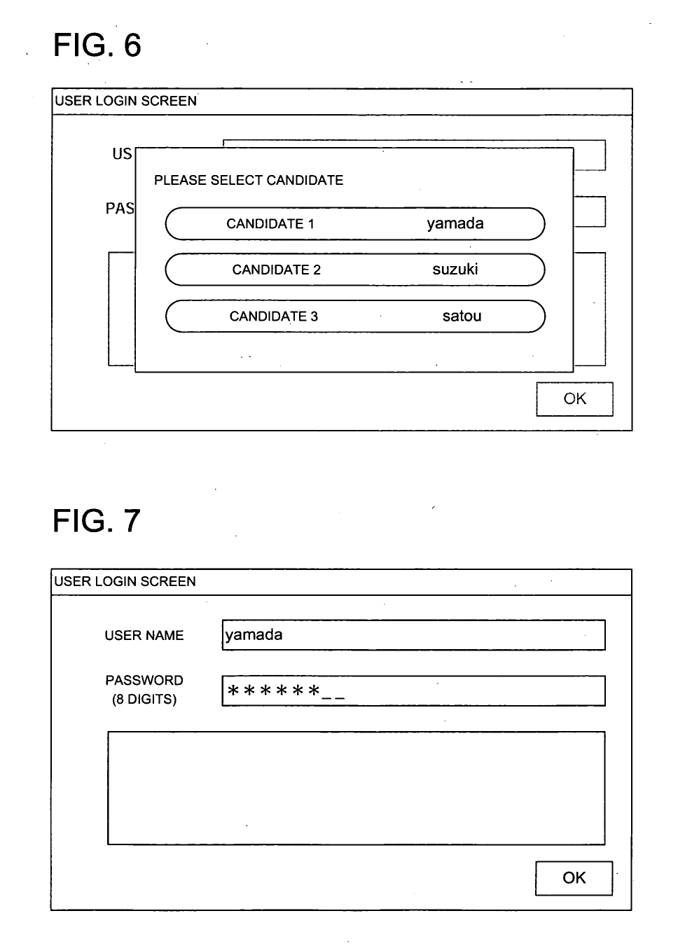

In Step S107, when it is judged that a plurality of candidates were extracted (Step S107: YES), the CPU 11 reads out the login ID corresponding to the registration numbers of the respective plurality of candidates that were added to the data from the non-volatile memory 18, and, for example, as is shown in FIG. 6, displays them in the display section 20 in decreasing order of the degree of matching as the login ID. By this, the user is prompted to select the login ID (Step S108). By displaying in decreasing order of the degree of matching, since the candidate that has a higher probability of being selected by the user is displayed close to the top, it is possible for the user to find easily the selection candidate from the list of candidates. In addition, when the number of candidates is large, if the display is made by restricting the candidates to the top few or to the top few percent, since the display is made by limiting to the candidates that have a high probability of being selected by the user, it is possible for the user to find easily the selection candidate from the list of candidates.

When it is judged that a plurality of candidates have not been extracted (Step S 107: NO), the processing proceeds to Step S110.

When the user selects using the operation section 19, following the display in Step S108, one of the candidates of the login IDs displayed in the display section 20, the selection information of the selection login ID is input to the CPU 11 (Step S109).

In Step S110, the CPU 11 reads out, from the non-volatile memory 18 into the RAM 14, the password corresponding to the selected login ID (if the processing jumped to this step from Step S109), or the login ID and password corresponding to the registration number (if the processing jumped to this step from Step S107: NO).

Next, the CPU 11 displays the login screen which displays the login ID read out in Step S107 and a part of the password in the display section 20, and prompts the user to make the completion input of the password (Step S111). For example, as is shown in FIG. 7, if the password has eight characters, the leading six characters of the password are input automatically and are displayed by six asterisks ‘*’ and the last asterisk ‘*’ is followed by the display of 2 underscored. characters. Following this display, the user makes the completion input of the password from the operation section 19. In the case of the example shown in FIG. 7, the user makes the completion input of the remaining two characters in the part displayed by underscores. By displaying the number of characters to be input using underscores etc., for example, even when a password with a large number of characters is being displayed, the user can immediately recognize which characters are to be input.

With this, the completion input of the password is made to the CPU 11 (Step S112). In the case of the example shown in FIG. 7, the login screen displays two asterisks ‘*’ in addition at the end of the six asterisks ‘*’ displayed earlier.

By making the user carry out completion input in this manner, even if the collation is successful while wrongly recognizing another person as the genuine user, since that other person cannot login as it is, but has to complete the password, another person logging in with the login ID and password of the genuine user is suppressed.

In Step S106, if authentication has failed (Step S106: NO), the operation proceeds to Step S113, and the CPU 11 displays, in the. display section 20, a login screen with the login ID and password fields empty, and prompts the user to enter the login ID and password. Following this instruction, the user enters all the characters of the login ID and password through the operation section 19.

For example, if the fingerprint registration condition is bad, and even if the fingerprint authentication has failed in spite of the user being the genuine user, it is possible for the user to login by inputting all the characters of the login ID and password.

In Step S114, all the characters of the login ID and password are input to the CPU 11.

In Step S112 or0 Step S114, when the login ID and password and input and logging in is made, the CPU 11 refers to the login IDs and passwords stored in the non-volatile memory 18 to cross-check with the entered login ID and password, and carries out authentication of the entered login ID and password (Step S115). If the authentication is successful (Step S115: YES), the CPU 11 outputs the use permission signal to the image forming apparatus (Step S116). If the authentication has failed (Step S115: NO), the CPU 11 outputs the use prohibit signal to the image forming apparatus (Step S117).

In the above manner, according to the present preferred embodiment, at the time of automatically inputting the login ID and password in the login ID field and the password field of the login input screen due to success of biometric authentication, since the entire password is not input automatically but a part of it is made to be entered by the user, not only that the input becomes simple at the time of logging in, but also logging in by another person using the login ID and password of the genuine user is suppressed. In addition, in the case when a plurality of candidates are extracted, since a plurality of candidates are displayed and the user is made to select among them, it is possible to definitively identify the desired user.

Although in the present preferred embodiment, in the case when a plurality of candidates of user are present, although the login IDs were displayed, it can be any information that can be recognized by the user instead.

Although in the present preferred embodiment the trailing part of the password was made the target of completion input by the user, it can also be the leading part or a middle part of the password. Since it is easy for the user to remember the leading and the trailing parts, it is desirable to use these for the completion input.

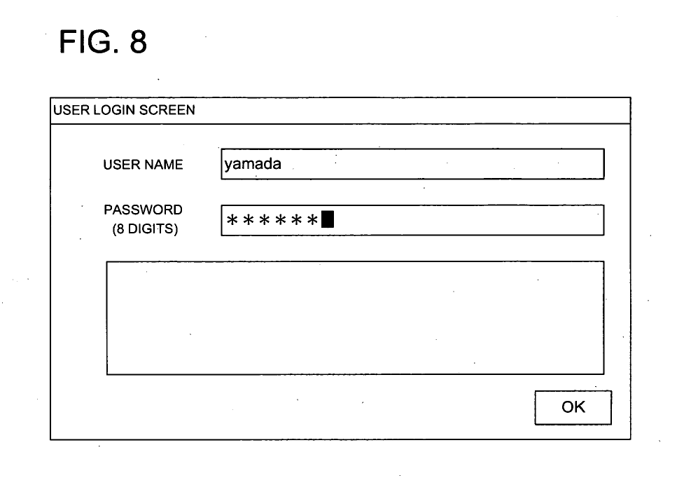

Further, although in the present preferred embodiment, the example of using a number of underscores equivalent to the number of characters of the completion input was explained as an example of the display for prompting for and accepting the input of completion input from the user, the present invention shall not be construed to be limited to this mode of display, and, for example, the display mode can also be line the one shown in FIG. 8. In the example of this figure, considering, for the sake of explanation, that the password has eight characters similar to that shown in FIG. 7, in addition to carrying out the automatic input of the leading six characters of the password and displaying them by six asterisks ‘*’, the prompt following the last asterisk character ‘*’ is displayed by a prompt character (for example, by a blinking cursor). In the example of this figure, the user carries out completion input of the remaining characters according to the prompt characters. Here, when the number of characters in the password differs depending on the user, only the genuine user can know how many characters have to be input following the prompt. In this manner, in the case of the present preferred embodiment, it is possible to make the number of characters of the password have the same kind of meaning as the password itself, and is desirably suitable for achieving security.

Although in the present preferred embodiment, the fingerprint data was stored in the non-volatile memory 36 of the fingerprint authentication module 30 while establishing correspondence with the registration number, the login ID and password were stored in the non-volatile memory 18 of the apparatus main unit 10 while establishing correspondence with the registration number, and the login ID and password corresponding to the fingerprint were identified by transmitting the registration number from the fingerprint authentication module 30 to the apparatus main unit 10 when the authentication by the fingerprint authentication module 30 was successful, it is also possible to store the login IDs and passwords in the non-volatile memory 36 of the fingerprint authentication module 30, and to transmit to the apparatus main unit 10 the login ID and the password stored in the non-volatile memory 36 from the fingerprint authentication module 30 when the authentication by the fingerprint authentication module 30 is successful.

Although in the present preferred embodiment, the fingerprint authentication module 30 was configured to be controlled by a CPU 31 that is other than the CPU 11 of the apparatus main unit 10, it is also possible to configure it so that it is controlled by the CPU 11 of the apparatus main unit 10.

Although in the present preferred embodiment, the user authentication method according to the present invention was used for apparatus use permission of the image forming apparatus, it is also possible to use the user authentication method according to the present preferred embodiment at the time of accessing the image data, document data, personal address books used for Scan to E-mail that are stored in the hard disk 17.

Although in the present preferred embodiment, the user authentication method according to the present invention was applied for an image forming apparatus, it goes without saying that the present invention can as well be applied to other apparatuses equipped with authentication functions, such as, in addition, personal computers, ATMs (Automatic Teller Machines), input/output control apparatuses etc.

Although in the present preferred embodiment, fingerprints were used for the authentication module, the present invention can also be applied to other biological information such as, for example, veins, face, iris, retina, voice prints, handwriting etc.

According to the present invention, at the time of automatically inputting the login ID and password in the login ID field and password field upon success of a biometric authentication, since all of the characters in the password are not input automatically but a part of it is being made to be input by the user, not only that the input at the time of logging in becomes simpler but also logging in by another person using the login ID and password of the genuine user is suppressed. In addition, when several candidates are extracted, since several candidates are displayed and the user is made to select among them, it is possible to identify the desired user definitely.

What is claimed is:

1. A user authentication method comprising the steps of:
accepting input of biological information;
displaying a user authentication screen in which a user name corresponding to the biological information and a part of a password corresponding to the user name are automatically entered; and
accepting input for completing the password, the part of which have been automatically entered.

2. The user authentication method of claim 1, wherein as the part of a password automatically entered, a character string which is missing a certain number of characters at a leading part or a trailing part of the password is automatically entered.

3. The user authentication method of claim 1, wherein the user authentication screen is displayed such that number of characters to be input for completing the password can be determined.

4. The user authentication method of claim 1, further comprising the step of authenticating the user name automatically entered and the password the part of which is automatically entered and completed by the input for completing the password, by cross-checking with previously stored user name and password.

5. The user authentication method of claim 4, further comprising the step of restricting use of an apparatus by a user of the user name, according to a result of the step of authenticating.

6. A user authentication method comprising the steps of:
accepting input of biological information;
extracting user data corresponding to the biological information accepted;
displaying user candidates based on the user data extracted;
accepting a selection of a specific user among the user candidates displayed;
displaying a user authentication screen in which a part of a password corresponding to the specific user selected is automatically entered; and
accepting input for completing the password, the part of which have been automatically entered.

7. The user authentication method of claim 6, wherein a user name corresponding to the specific user is also displayed.

8. The user authentication method of claim 6, further comprising the step of registering biological information previously, wherein in the step of extracting user data, the user data are extracted based on a degree of matching between the biological information accepted in the step of accepting input of biological information and the biological information previously registered in the step of registering, wherein in the step of displaying user candidates, the user candidates are displayed in decreasing order of the degree of matching.

9. The user authentication method of claim 8, in the step of displaying user candidates, a certain numbers or percentages of the user candidates from a top are displayed.

10. The user authentication method of claim 6, further comprising the step of determining whether one user data or plural user data are extracted in the step of extracting user data, wherein in cases where the one user data is extracted, displayed is the user authentication screen in which a part of a password corresponding to the one user data is automatically entered, in the step of displaying the user authentication screen.

11. An apparatus having a user authentication function, comprising:
a display section to display a user authentication screen;
an operation section for inputting into the user authentication screen; and
a controller to automatically enter a user name corresponding to biological information from a user and a part of a password corresponding to the user name, and to accept input for completing the password, the part of which have been automatically entered.

12. The apparatus of claim 11, wherein the control section authenticates the user name automatically entered and the password the part of which is automatically entered and completed by the input for completing the password, by cross-checking with previously stored user name and password.

13. An apparatus having a user authentication function, comprising:
a user data accepting section to accept input of user data;
a user candidate display section to display user candidates based on the user data accepted by the user data accepting section;
a user selection section to select a specific user among the user candidates displayed in the user candidate display section;
a display section to display a user authentication screen in which a part of a password corresponding to the specific user selected by the user selection section is automatically entered; and
a completion input accepting section to accept input for completing the password, the part of which have been automatically entered and displayed in the authentication screen.

14. The apparatus of claim 13, wherein the display section also displays a user name corresponding to the specific user in the user authentication screen.

15. A system having a user authentication function, comprising:
a biological information accepting section to accept input of biological information;
a display section to display a user authentication screen in which a user name corresponding to the biological information accepted by the biological information accepting section and a part of a password corresponding to the user name are automatically entered; and
a completion input accepting section to accept input for completing the password, the part of which have been automatically entered.

16. The system of claim 15, further comprising a control section to authenticate the user name automatically entered and the password the part of which is automatically entered and completed by the input for completing the password, by cross-checking with previously stored user name and password.

17. A system having a user authentication function, comprising:
a biological information accepting section to accept input of biological information;
a user extraction section to extract user data corresponding to the biological information accepted by the biological information accepting section;
a user candidate display section to display user candidates based on the user data extracted by the user extraction section;
a user selection section to select a specific user among the user candidates displayed by the user candidate display section;
a display section to display a user authentication screen in which a part of a password corresponding to the specific user selected by the user selection section are automatically entered; and
a completion input accepting section to accept input for completing the password, the part of which have been automatically entered and displayed in the user authentication screen.

18. The system of claim 17, wherein the display section also displays a user name corresponding to the specific user in the user authentication screen.

19. A computer readable recording medium in which recorded is a program executable by a computer for controlling an apparatus provided with a user authentication function, the program enabling the computer to execute the steps of:
displaying a user authentication screen in which a user name corresponding to the biological information accepted from a user and a part of a password corresponding to the user name are automatically entered; and
accepting input for completing the password, the part of which have been automatically entered.

20. The computer readable recording medium of claim 19, the user authentication function further comprising the step of authenticating the user name automatically entered and the password the part of which is automatically entered and completed by the input for completing the password, by cross-checking with previously stored user name and password.

21. A computer readable recording medium in which recorded is a program executable by a computer for controlling an apparatus provided with a user authentication function, the program enabling the computer to execute the steps of:
accepting input of user data;
displaying user candidates based on the user data accepted;
accepting a selection of a specific user among the user candidates displayed;
displaying a user authentication screen in which a part of a password corresponding to the specific user selected is automatically entered; and
accepting input for completing the password, the part of which have been automatically entered.

22. The computer readable recording medium of claim 21, in the step of displaying a user authentication screen, a user name corresponding to the specific user is also displayed in the user authentication screen.
